(19) United States
(12) Patent Application Publication
(10) Pub. No.: US 2013/0161337 A1
(43) Pub. Date: Jun. 27, 2013

(54) Insert liners

(71) Applicant: George William Skopis, Glenview, IL (US)

(72) Inventor: George William Skopis, Glenview, IL (US)

(21) Appl. No.: 13/694,059

(22) Filed: Dec. 7, 2012

Related U.S. Application Data
(60) Provisional application No. 61/569,659, filed on Dec. 12, 2011.

(51) Int. Cl. A21B 3/13

(52) U.S. Cl. CPC A21B 3/131
USPC 220/573.4

(57) ABSTRACT

Insert liners for cooking and baking containers that are larger than muffin pan liners is disclosed. A pre-formed, insert liner that is fitted to the internal size of the cooking or baking container, with an overhanging lip that fits over the top edges of the containers, stabilize the cooking insert liners, and helps to eliminate health and cleaning issues.

### BACKGROUND OF THE INVENTION

Problem Solved:

For health and easy cleaning purposes, cooking and baking containers, larger than muffin pans, require re-cleaning, prior to re-use. Flat liners or mats, don't protect the sides of the cooking containers from contamination, and require cleaning. A pre-formed, insert liner that is fitted to the internal size of the cooking or baking container, with an overhanging lip that fits over the top edges of the containers, stabilize the cooking insert liners, and helps to eliminate health and cleaning issues.

### DETAILED DESCRIPTION OF THE INVENTION

As stated above, for health and easy cleaning purposes, cooking and baking containers, larger than muffin pans, require re-cleaning, prior to re-use. The invention claimed here solves this problem. By having pre-formed, fitting insert liners, larger than muffin pan liners, made for cooking and baking containers, you can eliminate most health and clean-up issues, as the cooked or baked product doesn't come into contact with the container used for the process. The claimed invention differs from what currently exists. There are paper and aluminum foil and a combination of both, used as mats or liners, but they are flat, and not pre-formed to fit completely, and as a result some food comes into contact with the container and requires cleaning. The invention is an improvement on what currently exists. Flat liners or mats aren't stable and allow for food to come into contact with the container used in the process. They don't allow for easy transition to the meal table service. A pre-formed, insert liner that is fitted to the internal size of the cooking or baking container, with an overhanging lip That fits over the top edges of the containers, stabilize the cooking insert liners, and help eliminate health and cleaning issues.

The version of the invention discussed here includes:

1. Pre-formed aluminum foil

2. Pre-formed parchment or oven cooking and baking paper

3. A combination of sides, aluminum foil and oven baking or cooking paper

4. Oven acceptable resin made products such as silicone and like materials

### HOW THE INVENTION WORKS

The form fitted oven container insert liners act as a protective layer to the food that is to be cooked. They work as an internal insert to the oven container to help prevent health or cleaning issues, by protecting the oven container from contamination during the food cooking process.

### HOW TO MAKE THE INVENTION

The aluminum foil liners could be stamped by machine to sizes needed. The oven paper liners could also be stamped by machine or molded to sizes. The combination of aluminum foil and oven paper could be stamped and molded, as can resin or silicone liners.

### HOW TO USE THE INVENTION

Place the insert liner into the food preparation container, then put the food into the insert liner, then place it into the oven for desired completion. Additionally, the form fitted liners can be used as molds for refrigerator processes or for preparation process, such as salads and any other unusual need for liners in preparation processes.

### DRAWING DESCRIPTIONS “INSERT LINERS”

FIG. 1: is a perspective view of the invention square embodiment.

FIG. 2: is an exploded view of the invention square embodiment.

FIG. 3: is a perspective view of the invention rectangular embodiment.

FIG. 4: is an exploded view of the invention rectangular embodiment.

FIG. 5: is a perspective view of the invention round embodiment.

FIG. 6: is an exploded view of the invention round embodiment.

FIG. 7: is a perspective view of the invention oval embodiment.

FIG. 8: is an exploded view of the invention oval embodiment.

FIG. 9: is a detail section view taken along line 9-9 in FIG. 1.

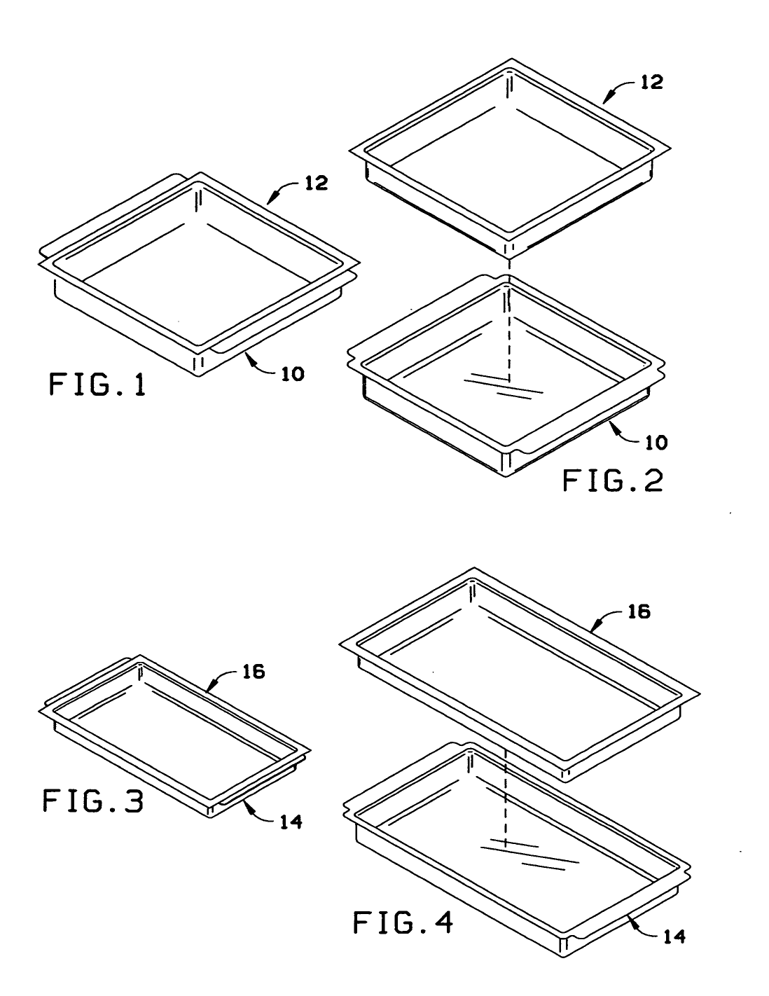

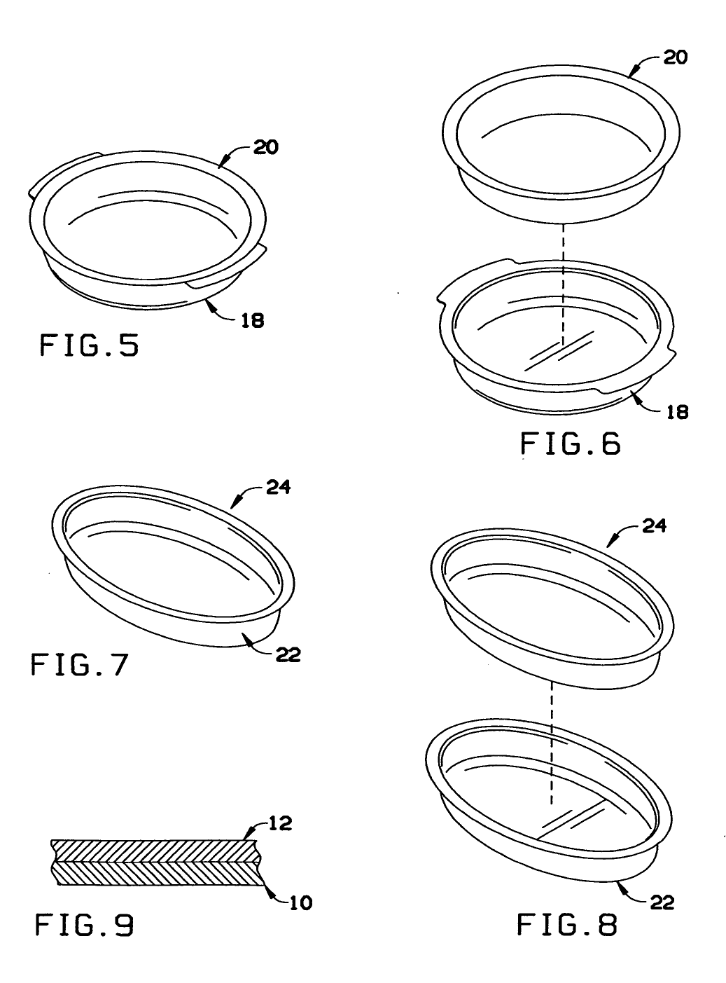

Description List

| | |
|---|---|
| 10: is the square container. | 12: is the square liner. |
| 14: is the rectangular container. | 16: is the rectangular liner. |
| 18: is the round container. | 20: is the round liner. |
| 22: is the oval container. | 24: is the oval liner. |

1. Preformed insert liners, larger then muffin pan liners, that fit the various internal sizes of baking, cooking or oven containers, including the sides and the tops of the containers for added stability, in order to enhance health and cleaning issues. Made from oven acceptable papers, resin products, aluminum foils or a combination thereof.
